(19) United States
(12) Patent Application Publication
(10) Pub. No.: US 2026/0275171 A1
(43) Pub. Date: Sep. 17, 2026

(54) ROLL WITH ADHESIVE ELEMENTS

(71) Applicant: TESA SE, Norderstedt (DE)

(72) Inventors: Morian TINSCHMANN, Norderstedt (DE); Tristan WIENZEK, Norderstedt (DE); Benjamin BRUMMER, Norderstedt (DE)

(73) Assignee: TESA SE, Norderstedt (DE)

(21) Appl. No.: 19/554,159

(22) Filed: Mar. 2, 2026

(30) Foreign Application Priority Data
Mar. 13, 2025 (DE) 102025109714.3

(51) Int. Cl. C09J 7/40; B26D 7/18; B26F 1/38; B32B 3/16; B32B 7/06; B32B 7/12

(52) U.S. Cl. CPC C09J 7/403; B26D 7/18; B26F 1/384; B32B 3/16; B32B 7/06; B32B 7/12; B32B 2405/00; C09J 2301/204; C09J 2301/302

(57) ABSTRACT

Rolls and/or reels of an adhesive element material web are disclosed and comprise at least one row of a multiplicity of adhesive elements, arranged sequentially with mutual spacing, which are applied on a release material in web form such that preferably the release material is on the inside of the winding and the adhesive elements are on the outside of the winding, wherein at least one edge or both edges of the release material have trapezoidal recesses which are present respectively between two adjacent adhesive elements, without the recesses undercutting the area of the adhesive elements, with the base of the trapezoidal recesses forming the notional edge of the liner.

This application claims foreign priority benefit under 35 U.S.C. § 119 of German Application No. 10 2025 109 714.3 filed Mar. 13, 2025.

### DESCRIPTION

The invention relates to a roll or reel of an adhesive element material web comprising at least one row of a multiplicity of adhesive elements, arranged sequentially with mutual spacing, which are applied on a release material in web form such that preferably the release material is on the inside of the winding and the adhesive elements are on the outside of the winding, and to a method for producing a roll or reel of an adhesive element material web.

The use of adhesive elements is an important part of many modern manufacturing processes today. Such adhesive elements are not only used to mount components on a substrate, but also serve in particular to close openings in a substrate. Such openings are usually present due to manufacture and represent possible weak points in the eventual product, through which moisture or contaminants may pass, for example. The use of suitable, usually one-sidedly adhesive elements for closing such openings in substrates is a simple, time- and cost-efficient solution for closing such openings and preventing unwanted ingress of contaminants; in the prior art, such adhesive elements are today already regularly used for this purpose and, as a result of their manufacturing process, are also referred to as die-cuts.

Especially in the manufacture of more complex structures made of metal sheets and/or plastics, constructional dictates make it impossible to avoid having to cut holes into the sheets or plastics in order to reach cavities behind them, whether for coating or for welding.

These openings are usually no longer required after the desired operation has been completed, and are often even disruptive, because air, humidity or water can penetrate the structure through them, possibly leading, for example, to oxidation processes (rust).

In principle, it is possible to place the corresponding adhesive elements manually on a substrate. However, in the course of advancing automation and in view of a continued interest in a process regime that is efficient and as little prone to error as possible, automatable application devices are being developed that serve the application of adhesive elements to a substrate on which bonding is to take place.

To optimize the handling efficiency and to avoid complex feeding systems, application devices are designed with an integrated dispenser arrangement for adhesive elements, in which the provision of the adhesive element and the application device can be implemented jointly, for example as part of an end effector of a robot head.

These adhesive elements are customarily provided in the form of adhesive element rolls or reels. For this purpose, an adhesive element material web, in which a multiplicity of adhesive elements arranged sequentially are applied on a release material in web form, also referred to as the liner, is wound up to form a roll or reel, specifically such that preferably the liner is on the inside of the winding and the adhesive elements are on the outside of the winding.

The liner (release paper, release film) is not a constituent of an adhesive tape or adhesive element (label), but merely an auxiliary for the production and/or storage thereof or for further processing by die-cutting. In addition, unlike the carrier layer in the adhesive tape or label, a liner is not firmly joined to a layer of adhesive.

On this liner, adhesive elements with a carrier layer and a layer of adhesive compound are arranged in series with mutual spacing in such a way that the free side of the adhesive compound layer is adhered on the liner, and so that the side of the adhesive compound layer lying opposite the liner is covered by the carrier layer, and so that the adhesive compound is completely protected.

Especially in the case of circular adhesive elements, it has emerged as advantageous for reasons of saving on material if the web of the liner is not shaped or cut such that the web has edges running straight in machine direction. If the web has edges running straight in machine direction, this type of manufacture means that a lot of liner material located between the adhesive elements is not utilized and is therefore wasted.

It is advantageous if the edges of the liner have a wave shape such as a sine curve. The concave portions of the liner envelop the respective adhesive element, while the convex portions form a recess between two adjacent adhesive elements, so that there is saving on material here.

Customarily, the individual adhesive element material webs are cut from a wide carrier web furnished with a large multiplicity of adhesive elements, in particular by rotary cutting, by, for example, blades which cut the wide carrier web into individual, narrow webs in machine direction.

The adhesive elements are located in numerous rows alongside one another on the wide carrier web. If one row of adhesive elements is arranged slightly offset from the adjacent row, the distances between the two rows can be reduced because the widest portions of the adhesive elements can each engage into regions between two successive adhesive elements of the adjacent row.

If a wave cut is made for separating the individual rows, the convex regions of one row fill the concave regions of the adjacent row, and vice versa.

Through this way of arranging the adhesive elements and of cutting, the consumption of liner is significantly reduced.

The method for producing adhesive element material web is addressed in detail later on.

Known from DE 10 2019 114 489 A1 is a method for the rotary die-cutting of film materials, in which the full utilization of material can be significantly increased and the proportion of “waste matrix” can thus be considerably reduced.

According to the method for rotary die-cutting of film materials, a film arrangement comprising a first carrier film and a film ply arranged over the first carrier film is first provided. First die-cuts are punched out of the film ply in such a way that after die-cutting, the first die-cuts are separate from a matrix-like residual film of the film ply surrounding the first die-cuts. The matrix-like residual film is peeled off from an arrangement comprising the first carrier film and the first die-cuts remaining on the first carrier film. The matrix-like residual film is arranged over a second carrier film. From the matrix-like residual film, second die-cuts are then punched out in such a way that after die-cutting, the second die-cuts are separate from a remaining part of the matrix-like residual film. The remaining part of the matrix-like residual film is peeled off from an arrangement comprising the second carrier film and the second die-cuts remaining on the second carrier film.

A variant of the method shows that the die-cuts are arranged in longitudinal direction in such a way that that no straight cut in longitudinal direction, i.e. no cut parallel to the longitudinal sides of the film, can be made between rows of the die-cuts arranged side by side in longitudinal direction, in order to separate the rows of the die-cuts arranged side by side in longitudinal direction from one another. Such a longitudinal cut would instead have to have a wavy shape, as indicated by a dashed line. As a result of such embodiment of the die-cuts, the material of the film ply can be optimally utilized.

However, the adhesive element material webs wound into rolls or reels, in which both edges of the liner are cut with wave shaping as outlined, have considerable disadvantages in automated dispensing operations.

In the dispensing process, the free end of the adhesive element material web is taken off from the roll or reel and guided into a dispensing device either until the adhesive element material web is guided over a dispensing edge, so that the adhesive elements at the dispensing edge detach from the liner, or until the adhesive element material web reaches a point at which the individual adhesive elements are removed from the adhesive element material web by means of a device such as a suction device and are dispensed at the desired position.

In the dispensing device, the adhesive element material web often undergoes edgewise guiding or diversion. In light of the fact that with a wave-shaped edge of the liner, there is in each case only one pointwise lateral contact face (at the largest width of the wave) to the guides of the dispensing device, stable guiding of the adhesive element material web is difficult. The adhesive element material web also tends to turn over at the contact points, owing to the pointwise pressure, which further degrades the precision with which the web can be guided.

The invention attempts to remedy this situation.

An object of the invention is to specify an adhesive element material web which can be precisely guided even edgewise in a dispensing device despite reduced surface area of the liner in the adhesive element material web, as is known for liners with wave-shaped cutting.

This object is achieved by a roll or a reel of an adhesive element material web as recorded in the main claim. The subjects of the dependent claims are advantageous developments of the subject of the invention and also methods for producing a roll or reel of an adhesive element material web.

The invention relates accordingly to a roll or reel of an adhesive element material web comprising at least one row of a multiplicity of adhesive elements, arranged sequentially with mutual spacing, which are applied on a release material in web form such that preferably the release material is on the inside of the winding and the adhesive elements are on the outside of the winding.

The variant wherein the release material is on the inside of the winding and the adhesive elements are on the outside of the winding is the preferred embodiment.

In addition, a winding is also possible in which the release material is on the outside of the winding and the adhesive elements are on the inside of the winding.

The adhesive element material web is provided as continuous product on rolls (Archimedean spiral), i.e. disc-shaped adhesive element material web rolls, which are referred to in the technical language as “pancakes”.

Alternatively, the adhesive element material web may be reeled up like a textile yarn on a core whose length is significantly greater than the width of the adhesive element material web. By superimposing a rotational movement of the core and an axial movement of the core or of the adhesive element material web guide member, the adhesive element material web first forms a first, radially innermost ply of helical turns. To complete the first layer and jump to the second layer, the orientation of the axial movement is inverted, with the rotational movement remaining unchanged. To complete the second layer and jump to the third layer, with the rotational movement remaining unchanged, the orientation of the axial movement is inverted again, i.e. returned to the original orientation. The slope angle remains constant between each of the orientation reversal points. In this way, numerous turn layers can be formed, with turns which cross each other (cross-wound reels).

Each adhesive element comprises at least one carrier layer and an adhesive layer comprising an adhesive compound, preferably pressure-sensitive adhesive compound, which is present on the surface of the carrier layer facing the release material.

It is essential to the invention that at least one edge, preferably both edges, of the release material have trapezoidal recesses, which are each present between two adjacent adhesive elements, without the recesses undercutting the area of the adhesive elements, with the base of the trapezoidal recesses forming the notional edge of the liner.

According to one preferred embodiment of the invention, the trapezoidal recesses are located in both edges of the release material.

In accordance with the invention, a trapezium, or trapezoid, is a quadrilateral with two opposite, parallel sides, which are referred to as base sides (“a” and “c”), the longer of the two sides being called the base (“c”). The remaining two sides (“b” and “d”) are called legs. Preferably, the two legs are the same length.

Preferably, the recesses have the shape of an isosceles trapezium. This occurs when the legs b and d are the same length. This makes the trapezium axially symmetrical. This means that the trapezium can be mirrored at a vertical line in the centre of the trapezium.

With further preference, all the recesses have the same trapezoidal shape.

According to a further advantageous embodiment of the invention, in each case the four corners forming a trapezoidal recess are not pointed but instead all have a radius, preferably all four having the same radius. With further preference, the corners of all trapezoidal recesses have the same radius.

This means that the pairs of edges forming a corner do not run towards each other in a pointed manner; instead, this point is rounded. The rounding significantly reduces the risk of a tear forming in a point.

Typically, the radius is between 2 and 6 mm, preferably 4 mm.

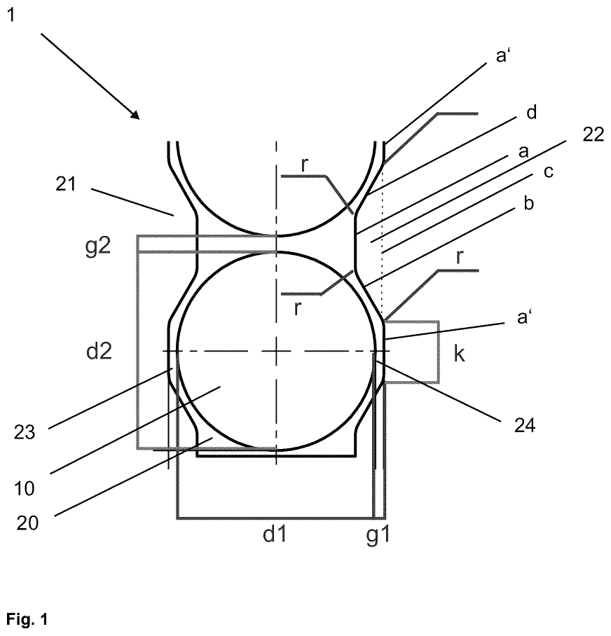

In FIG. 1, one particularly advantageous configuration of an adhesive element material web 1 according to the invention is shown.

Applied on a release material 20 in web form are a multiplicity of adhesive elements 10, arranged sequentially with mutual spacing.

The adhesive elements 10 are circular.

The width d1 of the adhesive elements 10 and the height d2 of the adhesive elements are identical for a circular shape and correspond to the diameter.

Typically, in the case of (preferably circular) adhesive elements 10, the width d1 and the height d2 are respectively between 10 and 50 mm, preferably between 20 and 40 mm, further preferably 35 mm.

The distance between the individual adhesive elements 10 is defined as the gutter height g2.

The gutter height g2 is typically between 1 and 5 mm, preferably between 2 and 3 mm.

In accordance with the invention, trapezoidal recesses 21, 22 are provided in both edges of the release material 20 at preferably regular intervals. Each trapezoidal recess 21, 22 has two base sides a, c and two equal-length legs b, d. The base c of the trapezoidal recesses 21, 22 forms the notional edge of the release material 20 (represented with a dot-dash line).

Located between the recesses 21, 22 are likewise trapezoidal portions 23, 24, in which the release material 20 has the largest width. The shorter base side a′ of the trapezoidal portions 23, 24 forms the edge of the release material 20. The length of this base side a′ is defined as length k.

The length k of this base side a′ is decisive for the protection of the adhesive elements 10 during transport and for handling and also for guiding in automatic dispensing devices.

The length k here is required to meet two opposing requirements.

Firstly, the length k should always be of maximum length, in order to meet the above-stated requirements. Secondly, the length k is to be minimized such that as far as possible no release material 20 is unnecessarily wasted.

As a result of the trapezoidal recesses 21, 22 provided according to the invention, a straight side edge a′ remains. This side edge a′ offers a very much larger contact face, allowing the adhesive element material web 1 to be guided more precisely through automatic dispensing devices. Fold-over of the release material 20, as can be observed in the case of wave-shaped cuts of the release material 20, is significantly reduced.

Another advantageous effect is that production costs can be lowered because less release material 20 is required, which also reduces CO₂ emissions by more than 10%.

The distance of the base side a′ from the adhesive element 10 in its largest extent (maximum width) is defined as gutter width g1. The gutter width g1 is typically between 1 and 3 mm, preferably 1.5 mm.

The length k depends on the width d1 of the adhesive element 10, the height d2 of the adhesive element 10, the gutter width g1, the gutter height g2 and the radius r.

If the adhesive elements 10 have an elongated shape, for example the typical oval shape of a stadium running track, wherein the adhesive elements 10 are aligned in machine direction, the length k is guided by the length of the adhesive elements 10.

An embodiment of the invention is particularly preferred if the radius r as a leading parameter for characterizing the invention meets the following condition:

$$r \geq 0 and r < d 1 + g 1$$

If r were such that r=d1+g1, there would no longer be any lateral edge, irrespective of the variables (d2, g2).

According to another advantageous embodiment of the invention, the trapezoidal recesses 21, 22 and the trapezoidal portions 23, 24 are congruent; that is, they have equal surface area. This variant is particularly advantageous if the adhesive elements 10 are circular.

Further preferably, a trapezoidal recess is located between each of the adhesive elements which are arranged sequentially with mutual spacing.

The production of the adhesive element material web wound to form the roll or the reel takes place according to the known methods.

First, a wide web of carrier layer is furnished with the adhesive layer and lined with a release material. This wide web can be wound into a so-called master roll. In the next step, the master roll is unwound again. The intermediate step of winding and unwinding is not mandatory.

In a rotary die-cutting process, adhesive elements are punched from the carrier layer furnished with an adhesive layer and the protruding matrix is removed.

The adhesive elements after die-cutting are customarily arranged in a plurality of parallel rows in longitudinal direction on the release material. The adhesive elements have a spacing in both longitudinal and transverse directions.

In the case of products that are supplied in single-row form—that is, in which the adhesive elements are arranged side by side in one row in the longitudinal direction of the release material-individual webs of the release material with the respective adhesive elements arranged side by side are cut in longitudinal direction after the die-cutting operation.

Preference is given to a single-row adhesive element material web, i.e. an adhesive element material web in which the adhesive elements are arranged sequentially in a single row in the longitudinal direction of the release material.

It is also in accordance with the invention for two, or multiple, rows of adhesive elements to be present on an adhesive element material web, with the adhesive elements in each case arranged sequentially in the longitudinal direction of the release material. The rows are preferably arranged such that the individual adhesive elements lie side by side on the release material in as dense a packing as possible, in order to utilize as little release material as possible. A further advantage of this space-saving arrangement is that the matrix area to be removed is also reduced, which means that there are also savings in terms of carrier layer and adhesive layer. It is essential to the invention that the release material has trapezoidal recesses at one or both edges.

Particularly preferred is the following method for producing a roll or reel of an adhesive element material web, comprising the following steps:
i) furnishing of a wide web of carrier layer with an adhesive layer and lining with a release material
ii) optionally, winding to a master roll
iii) optionally, unwinding of the master roll
iv) rotary die-cutting of adhesive elements and stripping of the protruding material
v) cutting of adhesive element material webs from the master roll web with trapezoidal edges of the release material in accordance with the invention.

Preferred in accordance with the invention is an adhesive element having a basic shape which has a closed geometric shape, i.e. generally a rounded convex figure, and more particularly is selected from the group consisting of circles, partial circles, more particularly semicircles, ovals or polygons. Triangular or rectangular shapes are also possible. The adhesive elements may also have rounded corners.

Preferably, the shape is selected from the group consisting of circles, semicircles and ovals. A circular adhesive element is particularly preferred.

The adhesive elements preferably comprise a carrier layer and an adhesive layer joined thereto, wherein the adhesive elements are arranged with the adhesive layer on the release material.

It is customary that the adhesive elements are pressure-sensitive adhesive elements and/or the adhesive layer comprises a pressure-sensitive adhesive compound, wherein the adhesive layer preferably consists of a pressure-sensitive adhesive compound.

The adhesive compound layer is generally applied over the entire area of the carrier layer.

The adhesive elements may also have a plurality of adhesive layers, which may be present within the carrier layer, for example to fix the plies within the carrier layer.

For the adhesive layer of the adhesive elements, the skilled person is able to recruit customary adhesive compounds known in the field of adhesive technology, for example poly(meth)acrylate-based and/or rubber-based systems. The corresponding adhesive layer is arranged in an industry-standard manner on a carrier layer, which is usually formed from a plastic. Although it is theoretically possible to process double-sidedly adhesive elements, single-sidedly adhesive elements are in practice used first and foremost.

The carrier layer can be single-ply or multi-ply: for example, different film plies may together form a carrier layer. The carrier layer may comprise one or more materials selected from the group consisting of polyethylene, polypropylene, cyclic olefin copolymers, polyvinyl chloride, polyester, ethylene-vinyl alcohol, polyvinylidene chloride, polyvinylidene fluoride, polyacrylonitrile, polycarbonate, polyamide, polyethersulfone and polyimide, preferably selected from the group consisting of polyethylene, polypropylene and polyethylene terephthalate, with the carrier layer preferably consisting of these materials.

The adhesive elements are arranged on the release material. Corresponding release materials in web form are comprehensively familiar to the skilled person from the field of adhesive technology, and are referred to presently as release materials, because the adhesive elements arranged thereon can be easily separated from them as a result of reduced adhesion at the surface. The functionality of the release materials can be achieved by customary release layers known to the skilled person, which are applied to the surface of the release materials, where they cover, for example, the base layer of plastic or paper. In other words, it is usually the case with a method according to the invention that the first release material in web form and/or the second release material in web form, preferably all release materials in web form, are liners. In a typical method according to the invention, the first release material in web form and/or the second release material in web form, preferably all release materials in web form, is coated on the side facing the adhesive elements with a release layer, preferably with a silicone release layer, wherein the silicone release layer is preferably producible by crosslinking a crosslinkable silicone system comprising one or more polysiloxanes.

In addition to FIG. 1, figures are elucidated below which show the cutting of adhesive element material webs from a master roll web, and a roll of adhesive element material web, without wishing to restrict the invention unnecessarily. The figures show:

FIG. 1 a particularly advantageous configuration of an adhesive element material web according to the invention,

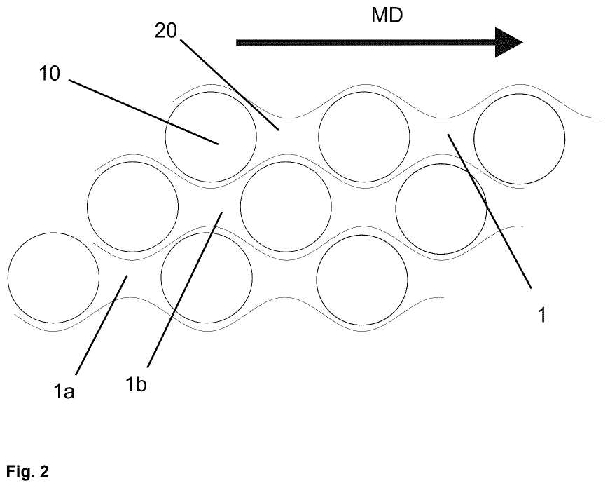

FIG. 2 the cutting of adhesive element material webs from a master roll web with wave-shaped edges of the release material (according to the prior art),

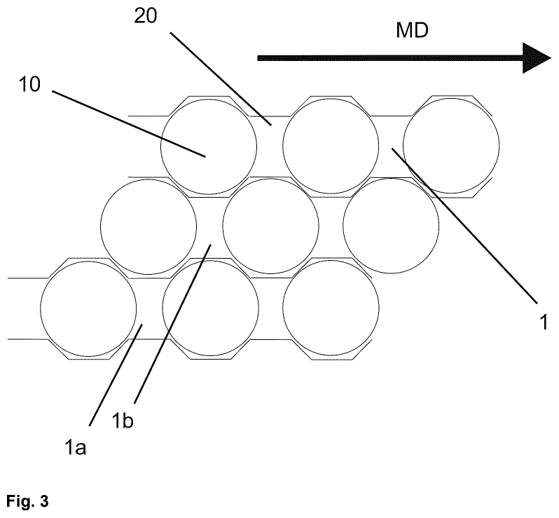

FIG. 3 the cutting of adhesive element material webs from a master roll web with trapezoidal edges of the release material in accordance with the invention and

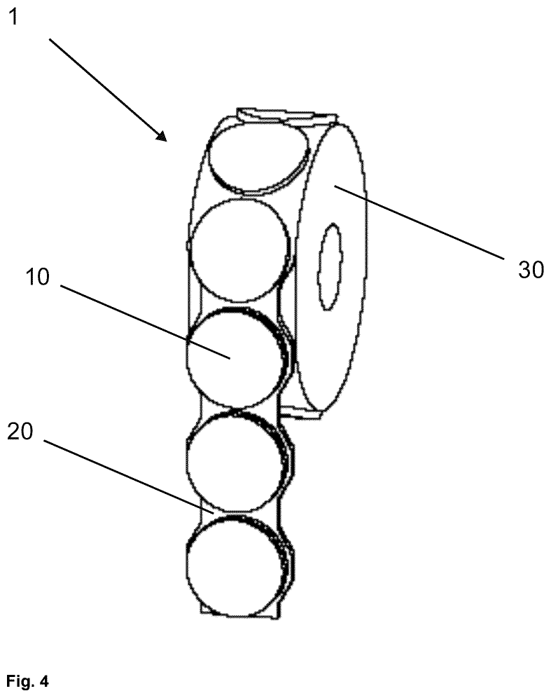

FIG. 4 a roll of an adhesive element material web comprising a multiplicity of adhesive elements, arranged sequentially with mutual spacing, which are applied on a release material in web form.

In FIG. 2, the cutting of a plurality of adhesive element material webs 1, 1a, 1b from a master roll web is shown. For this purpose, the master roll web with the adhesive elements located on the release material 20 is cut in machine direction MD into individual adhesive element material webs 1, 1a, 1b, the cut being made such that the release material 20 of the adhesive element material webs 1, 1a, 1b has wave-shaped edges.

This wave-shaped cut is known in the state of the art.

In FIG. 3, the cutting of several adhesive element material webs 1, 1a, 1b from a master roll web is likewise shown. For this purpose, the master roll web with the adhesive elements located on the release material 20 is cut in machine direction MD into individual adhesive element material webs 1, 1a, 1b, the cut being made such that the release material 20 of the adhesive element material webs 1, 1a, 1b has trapezoidal edges.

This trapezoidal cut is not known in the prior art.

FIG. 4 shows a roll 30 of the invention composed of an adhesive element material web 1 comprising a multiplicity of adhesive elements 10, arranged sequentially with mutual spacing, which are applied on a release material 20 in web form such that the release material 20 is on the inside of the winding and the adhesive elements 10 are on the outside of the winding.

### LIST OF REFERENCE NUMERALS

1, 1a, 1b adhesive element material webs
10 adhesive element
release material
21, 22 trapezoidal recesses
23, 24 trapezoidal portions
30 roll of an adhesive element material web

1. A roll or a reel of an adhesive element material web comprising at least one row of a multiplicity of adhesive elements, arranged sequentially with mutual spacing, which are applied on a release material in web form such that the release material is on the inside of the winding and the adhesive elements are on the outside of the winding,
wherein
each adhesive element has a carrier layer and an adhesive layer, comprising an adhesive compound, preferably pressure-sensitive adhesive compound, which is present on the surface of the carrier layer facing the release material,
and
at least one edge or both edges of the release material have trapezoidal recesses which are present respectively between two adjacent adhesive elements, without the recesses undercutting the area of the adhesive elements, with the base of the trapezoidal recesses forming the notional edge of the liner.

2. The roll or the reel of claim 1, wherein the trapezoidal recesses have the shape of an isosceles trapezium.

3. The roll or the reel of claim 1, wherein the trapezoidal recesses all have the same trapezoidal shape.

4. The roll or the reel of claim 1, wherein, in each corner of the four corners forming a trapezoidal recess have a radius

5. The roll or the reel of claim 4, wherein each radius of each corner is the same radius r.

6. The roll or the reel of claim 5, wherein the same radius r meets the following condition:
r≥0 and r<d1+g1

7. The roll or the reel of claim 1, wherein the adhesive element has a base shape which has a closed geometric shape selected from the group consisting of circles, partial circles, semicircles, ovals and polygons.

8. The roll or the reel of claim 1, wherein the adhesive elements comprise a carrier layer and an adhesive layer joined thereto, wherein the adhesive elements are arranged with the adhesive layer on the release material.

9. A method for producing the roll or the reel according to claim 1, the method comprising:
i) furnishing of a wide web of carrier layer with an adhesive layer and lining with a release material;
ii) optionally, winding to a master roll;
iii) optionally, unwinding of the master roll;
iv) rotary die-cutting of adhesive elements and stripping of the protruding material; and
v) cutting of adhesive element material webs from the master roll web with trapezoidal edges of the release material in accordance with the invention.
